(19) United States
(12) Patent Application Publication
(10) Pub. No.: US 2013/0155661 A1
(43) Pub. Date: Jun. 20, 2013

(54) COMPUTER ENCLOSURE WITH LIGHT-EMITTING DIODES

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/441,851

(22) Filed: Apr. 7, 2012

(30) Foreign Application Priority Data
Dec. 20, 2011 (CN) 201110429266.4

(51) Int. Cl. F21L 4/00

(52) U.S. Cl. 362/183

(57) ABSTRACT

A computer enclosure includes a chassis, a power supply, a light-emitting diode (LED) mounted on an inside surface of the chassis, a battery, a driving circuit connected between the battery and the LED, a switch connected between the battery and the driving circuit, and a charging circuit connected between the power supply and the battery for charging the battery. When a user turns on the switch, the battery is caused to supply power to the driving circuit turning on the LED.

### BACKGROUND

1. Technical Field

The present disclosure relates to a computer enclosure with light-emitting diodes.

2. Description of Related Art

When a motherboard or a memory in a computer system does not operate, an operator needs to open an enclosure of the computer system to check the motherboard or the memory. However, the computer may be, for convenience, located under a desk and where the ambient light may not be optimum for viewing the inside of the enclosure of the computer. Hence, the operator must move the enclosure to where there is light, which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an exemplary embodiment of a computer enclosure.

FIG. 2 is a block diagram of the chassis of FIG. 1, wherein the computer enclosure includes a driving circuit.

FIG. 3 is a circuit diagram of the driving circuit of FIG. 2.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

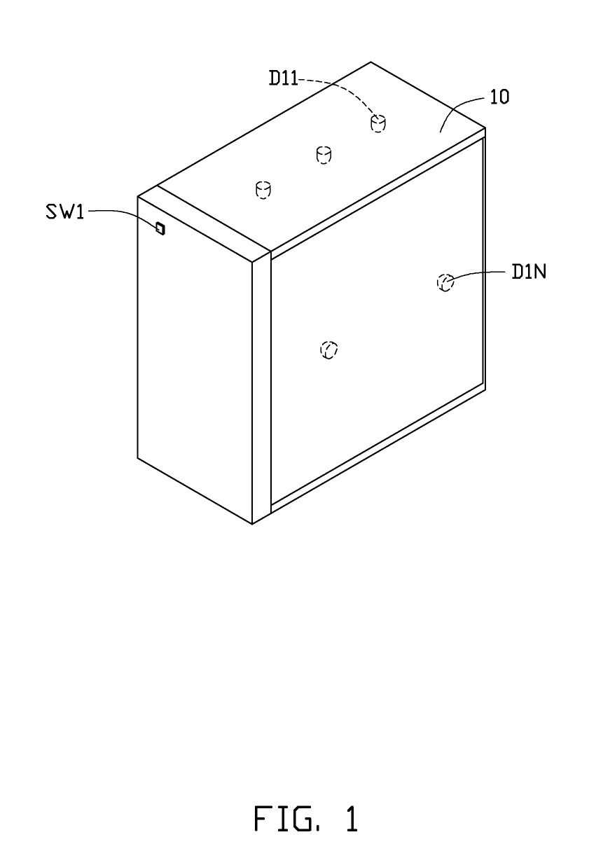

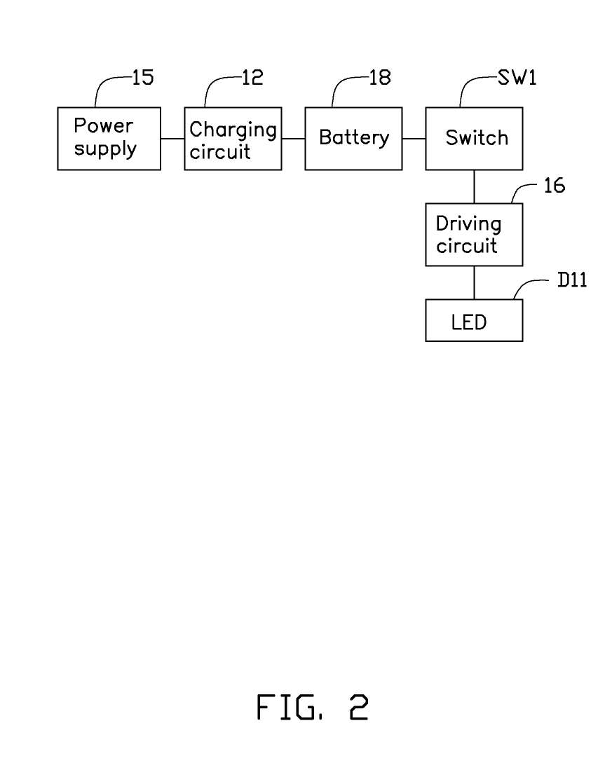

Referring to FIGS. 1 and 2, an exemplary embodiment of a computer enclosure includes a chassis 10, a plurality of light-emitting diodes (LEDs) D11-D1N, a battery 18, a charging circuit 12, a driving circuit 16, a switch SW1, and a power supply 15. The LEDs D11-D1N, the battery 18, the charging circuit 12, and the driving circuit 16 are all arranged on an inside surface of the chassis 10. The switch SW1 is arranged on an outside surface of the chassis 10. The power supply 15 is arranged in the chassis 10.

Because the LEDs D11-D1N are mounted on an inner side of the chassis 10, when the LEDs D11-D1N are turned on, the LEDs D11-D1N can light up the inside of the chassis 10.

The charging circuit 12 is connected between the battery 18 and the power supply 15 to charge the battery 18.

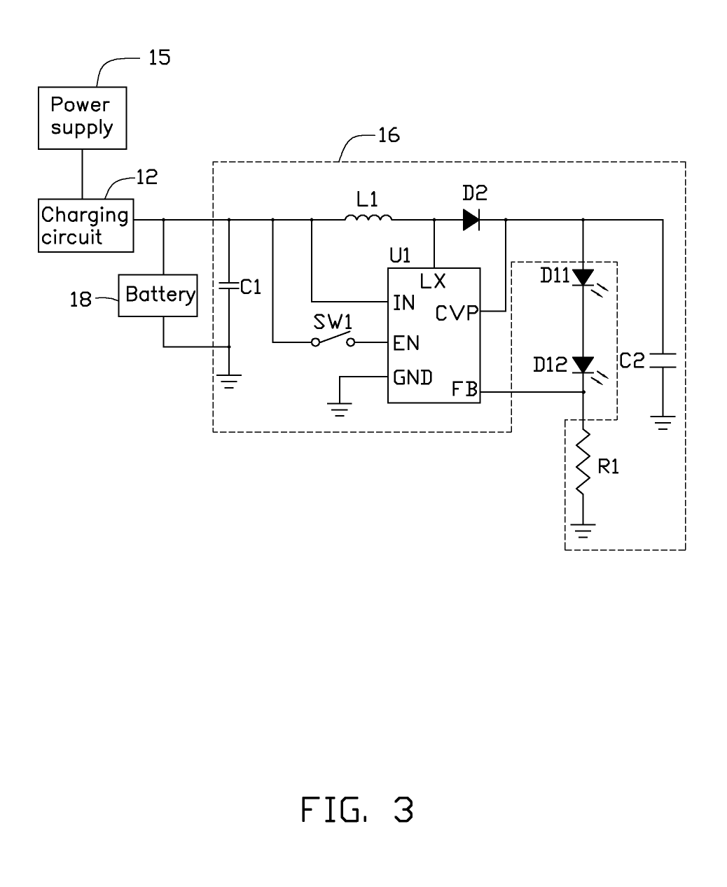

Referring to FIG. 3, the driving circuit 16 includes a chip U1, two capacitors C1 and C2, a resistor R1, an inductor L1, and a diode D2. An input pin IN of the chip U1 is connected to a positive terminal of the battery 18. An enable pin EN of the chip U1 is connected to the input pin IN through the switch SW1. The positive terminal of the battery 18 is further grounded through the capacitor C1. A ground pin GND of the chip U1 is grounded. An output pin LX of the chip U1 is connected to the input pin IN through the inductor L1, and is further connected to an anode of the diode D2. A cathode of the diode D2 is connected to a detection pin CVP of the chip U1 and an anode of the LED D11. A cathode of the LED D11 is connected to an anode of the LED D12. A cathode of the LED D12 is grounded through the resistor R1, and is further connected to a feedback pin FB of the chip U1. The cathode of the diode D2 is grounded through the capacitor C2. In this embodiment, for describing the circuit conveniently, only two LEDs are used. In other embodiments, there can be more than two LEDs, which may be connected in series or in parallel.

A user can turn the switch SW1 on and off, to control the battery 18 supplying power to the LEDs D11-D1N through the driving circuit 16. In addition, the power supply 15 can charge the battery 18 through the charging circuit 12.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A computer enclosure, comprising:
a chassis;
a power supply received in the chassis;
a light-emitting diode (LED) mounted on an inside surface of the chassis, wherein when the LED is turned on, the LED lights up an inside of the chassis;
a battery;
a driving circuit connected between the battery and the first LED for activating the LED when the battery supplies power to the driving circuit;
a switch connected between the battery and the driving circuit for controlling the battery to supply power to the driving circuit or not; and
a charging circuit connected between the power supply and the battery for charging the battery.

2. The computer enclosure of claim 1, wherein the driving circuit comprises a chip, a first capacitor, a second capacitor, a resistor, an inductor, and a diode, an input pin of the chip is connected to a positive terminal of the battery, an enable pin of the chip is connected to the input pin through the switch, the positive terminal of the battery is grounded through the first capacitor, a ground pin of the chip is grounded, an output pin of the chip is connected to the input pin though the inductor, and is further connected to an anode of the diode, a cathode of the diode is connected to a detection pin of the chip, and is further connected to an anode of the LED, a cathode of the LED is connected to a feedback pin of the chip, the cathode of the LED is grounded through the resistor, the cathode of the diode is grounded through the second capacitor.
